(19) United States
(12) Patent Application Publication
(10) Pub. No.: US 2021/0333128 A1
(43) Pub. Date: Oct. 28, 2021

(54) INDUCTIVE DETECTION OF A ROTATIONAL ANGLE

(71) Applicant: ZF Friedrichshafen AG, Friedrichshafen (DE)

(72) Inventors: Ajoy PALIT, Bremen (DE); Jörg GROTENDORST, Nürnberg (DE)

(73) Assignee: ZF Friedrichshafen AG, Friedrichshafen (DE)

(21) Appl. No.: 17/312,591

(22) PCT Filed: Dec. 6, 2019
(86) PCT No.: PCT/EP2019/084079

§ 371 Date: Jun. 10, 2021

(30) Foreign Application Priority Data
Dec. 10, 2018 (DE) 10 2018 221 317.8

(51) Int. Cl. G01D 5/20; G01B 7/30

(52) U.S. Cl. CPC G01D 5/202; G01B 7/30

(57) ABSTRACT

A sensor arrangement for detecting a rotational angle of a flux element on a circular path about a rotational axis contains coil groups having flat coils in the same rotational angle region on a plane concentric with the rotational axis in parallel with the circular path, the inductance of the flat coils being dependent on the rotational angle of the flux element. An evaluation device evaluates the inductance and individual rotational angle of the flux element for each flat coil and the rotational angle from at least two matching individual rotational angles. In an electric machine, the flux element is coupled to the rotor and the coil groups are coupled to the stator, or vice versa. A corresponding method is also disclosed.

The invention relates to the detection of a rotational angle, in particular for an electric machine.

Electric machines (rotating electric motors/generators) in vehicles are required in the context of electric mobility, for example. In many cases, detecting rotational angle for the electric machine (rotational angle of a rotor in relation to a stator) here is desired or necessary.

For example, an inductive rotor position sensor is known from “Sumida Press Release, ‘SUMIDA CORPORATION introduces Inductive Rotor-Position Sensor to Hybrid Electric Vehicles Market’, https://www.sumida.com/userfiles/NEWS_EVENTS/PRODUCTS/100420_RotorPositionSensor/20100420_E.pdf, downloaded on 11/30/2018”.

The invention is based on the object of improving the inductive detection of a rotational angle.

The object is achieved by a sensor assembly for detecting rotational angle of a flux element which is rotatable along a circular path about a rotation axis. Preferred or advantageous embodiments of the invention as well as of other categories of the invention are derived from the further claims, from the description hereunder as well as from the appended figures.

The sensor assembly contains at least one, in particular one, two, three or four, flux elements. The flux element has in particular a radial spacing from the rotation axis, said radial spacing being unequal to zero, and/or is a passive flux element. The flux element is in particular fixedly mounted on a support, wherein in this instance the entire support conjointly with the flux element is rotatable about the rotation axis. The support can be part of the sensor assembly. The sensor assembly in this case also serves for determining a current rotational angle of the support about the rotation axis.

The sensor assembly moreover contains at least one, in particular one, two, three, four, five or six, coil groups. Each of the coil groups contains in each case at least one, in particular one, two or three, flat coils. A total of at least two flat coils are present. The flat coils extend in each case along a face. The face concentrically surrounds the rotation axis. The face runs in parallel along the circular path. All flat coils of a coil group, and thus also the entire coil group, extend in each case across the same rotational angle range in relation to the rotation axis. The sensor assembly contains in particular at least two coil groups, each having at least two flat coils. The adjunct “flat” in “flat coil” here refers to the face, that is to say that the flat coils extend so as to be planar, or in a planar manner, in the face.

The flat coils are shaped in such a manner that a current inductance of each flat coil is a function of the current rotational angle of the flux element in relation to the rotation axis, that is to say of the circumferential position of said flux element along the circular path.

The sensor assembly furthermore contains an evaluation installation. The latter, for example by hardwiring or programming, is specified for determining for each of the flat coils the current inductance thereof at a specific point in time. Said evaluation installation is furthermore specified for determining current respective individual rotational angle of the flux element by means of the determined inductance of the respective flat coil. Said evaluation installation is furthermore specified for providing the rotational angle of the flux element based on at least two matching individual rotational angles of two different flat coils. The individual rotational angles here have to match in the context of an acceptable error range. Alternatively, an error measure is initiated, for example an error report emitted, if it is not the case that at least two individual rotational angles correspondingly match.

At least one of the coil groups contains in particular a (third), or even more, further flat coils. The latter in this instance introduce a further degree of redundancy into the sensor assembly or coil groups, because further individual rotational angles are determined and made available for evaluation for the same relative position between the flux element and the coil group.

The sum of all rotational angle ranges is in particular at least 360° so that all potential rotational angles of the flux element about the rotation axis can be detected.

The flat coils are thus shaped in such a manner that a current inductance of each flat coil is a function of the position of the flux element along the circular path. In other words, different rotational angles to be determined can be unequivocally differentiated by means of the determined inductances.

Practically any arbitrary number of rotational angles of the flux element can be determined by the sensor assembly. It is not necessary for one flat coil to be assigned to a rotational angle to be determined. A number and/or position of rotational angles to be determined can be freely chosen and be varied at any arbitrary point in time. The sensor assembly can be flexibly used for different specific applications, and rotational angles to be identified can be calibrated when required. For example, the sensor assembly can be used for an electric machine, for determining the current rotational angle of the rotor in relation to a stator.

By determining the rotational angle of the flux element by means of three flat coils in a coil group, a degree of redundancy can be achieved which permits an operation of the sensor assembly, or a correct identification of the rotational angle, respectively, even when one of the flat coils should fail, for example by virtue of a short circuit or an interruption of the coil wire.

A spacing between the circular path and the face is furthermore preferably constant. The circular path can also preferably follow the face at a constant spacing.

The invention can in particular be used for identifying the position of the rotor in electric machines or motors/generators, in particular in the field of electric mobility.

The present invention utilizes at least two, in particular three, flat coils which, in particular in the radial direction, in the axial direction or in a combined radial/axial direction, are disposed next to one another in relation to the rotation axis. In terms of the length of said flat coils, the latter in the circumferential direction are shaped or bent, respectively, in the shape of circular segments or in an arcuate shape, in the same or similar manner about the rotation axis.

The invention is based inter alia on the concept that the exact measurement of the rotational angle of a rotor is very important for an electric motor which is based on electric mobility projects. By virtue of a large obstacle on a road it is conceivable that wheels of an electromobile cannot travel forward. Consequently, a “blocked rotor” state arises for the electric motor. This state can be identified using a rotational angle position sensor for the rotor. Otherwise, a MOSFET-based H-bridge or the motor could burn out in a “blocked rotor” state.

Thanks to the invention, the correct rotational angle position of the rotor can be determined, and a suitable measure can be initiated so as to prevent the above-mentioned situation, that is to say that the destruction of the H-bridge or of the motor per se on account of a high current flow can be avoided.

According to the invention, two or three flat coils which are trapezoidal (in a plane) are converted from a planar to a bent shape so that said flat coils fit into the concentric face about the rotation axis. The flat coils here are in particular printed directly onto a circuit board. The circuit board here can be fastened internally to a stationary or fixed part of an electric motor, for example to the stator.

Furthermore, a thin conductive board (flux element) of copper/aluminum, in particular having a special shape or contour, is in particular fastened to a non-conducting disk or a cylinder (support) and fixedly fastened to the rotating rotor shaft. Consequently, the board slides across the flat coils when rotated about the rotation axis. This combination of flat coils and a flux element (copper activator element) forms the base of an inductive rotational angle sensor (inductive rotor position sensor IRPS). The rotational angle of the rotor is computed based on the above-mentioned signals. A coil group of three such trapezoidal flat coils (bent in a rotary shape) covers in particular a rotational angle range about the rotation axis of at least 60°, at most 90°. Therefore, at least four coil groups (4×90°=360°) or at most six coil groups (6×60°=360°) of two or three such trapezoidal flat coils of rotary shape are required for measuring a full rotational range (360°) of the rotor position (rotational angle), wherein said trapezoidal flat coils do not overlap one another and seamlessly adjoin another in the circumferential direction about the rotation axis.

In one preferred embodiment, the sensor assembly contains at least two coil groups. At least two of the coil groups extend across different rotational angle ranges in the circumferential direction about the rotation axis. The rotational angle ranges at least do not fully overlap in the circumferential direction, preferably do not overlap at all. At least two of the rotational angle ranges are in particular of identical size (in the circumferential direction). In particular with a view to an overall detection about the rotation axis, individual flat coils thus have to cover only a specific rotational angle range but not the full circumference, and can thus be of simpler embodiment.

In one preferred variant of this embodiment, at least two, in particular all, of the rotational angle ranges do not overlap one another and seamlessly adjoin one another in the circumferential direction. An ideally large overall rotational angle range of the mutually adjoining individual rotational angle ranges can thus be detected using flat coils which in the circumferential direction extend across a comparatively small individual rotational angle range. In particular, four rotational angle ranges of each 90°, or six rotational angle ranges of each 60°, are provided so as to implement each 360° rotational angle detection.

In one preferred embodiment, the face is planar and extends transversely to the rotation axis. The face thus describes an annular shape. Alternatively, the face about the rotation axis has a conical shape or a circular conical shape or the shape of a lateral surface of an, in particular right, circular cylinder. Corresponding faces, and thus also flat coils, which extend along these faces can be implemented in a particularly simple manner.

In one preferred embodiment the flux element has a sinusoidal characteristic along the circular path. The characteristic relates in particular to the shape, the material, the thickness (radial or axial direction, or a combination thereof), the width (axial or radial direction, or a combination thereof), of the flux element. The flat coil in this case can in particular be embodied so as to have homogenous or consistent, respectively, characteristics (width, thickness, material, number of windings, geometry, etc.), in particular in the circumferential direction, and thus be of a particularly simple embodiment.

In one preferred embodiment at least one of the flat coils is shaped in such a manner that the size of a region of a flat coil in the face covered by the flux element is in each case a function of the current rotational angle of the flux element, thus of the position of the flux element along the circular path. The region covered by the flux element can be determined by means of a projection of the flux element onto the face, or the flat coil, respectively, in the direction of the normal of the face. The projection direction here is in particular directed in the direction of a line onto the flat coil which is perpendicular to the circular path. The entire region which the flux element by way of the different rotational angles thereof can cover in the face is in each case preferably covered by at least one of the flat coils. The larger the region of a flat coil that is covered by the flux element, the larger the influence of said region on the inductance of said flat coil. By linking the covered region of a flat coil and the rotational angle, the inductance of the flat coil can be a function of the rotational angle of the flux element so that the rotational angle can be determined based on the induction.

The circular path typically, or in a preferred embodiment, respectively, extends between a start angle and a finish angle. A width of a first flat coil, and in particular of a third flat coil should the latter be present, of at least one coil group here decreases transversely to the circular path, from the start angle to the finish angle, while a width of a second flat coil of the same coil group increases in the same direction from the start angle to the finish angle. As a result, the flat coils can be disposed in an improved compact manner. The first flat coil and the third flat coil in terms of the above-mention case can in particular be conceived such that the inductances of said flat coils correspond to one another at each rotational angle of the flux element.

In one preferred embodiment, the second flat coil for at least one of the coil groups, the latter here containing at least three flat coils, lies in a direction transverse to the circular path between the first and the third flat coil. As a result, a particularly compact construction of the flat coils can be implemented. Moreover, any mutual influence of neighboring flat coils can be minimized.

In one preferred embodiment the flat coils of at least one of the coil groups conjointly occupy an annular segment or a cone shell or a right circular-cylindrical shell of the face. As a result, the flat coils can be of a compact construction and conjointly be easily disposed or installed. The flux element here can in particular have a rectangular shape (in the context of being “wound up” or “bent” along the face or parallel to the latter, respectively), wherein widths of the flux element and of the face of the flat coils can be identical, and a length of the flux element in the direction of the circular path is preferably less than the length of the face of the flat coils.

A flat coil typically comprises a plurality of windings which lie in the face. An innermost winding can have the shape of an originally planar trapezoid or triangle which has been “rolled up” or “bent” on the face, and windings further outside can in each case have a constant spacing from the next, further inward, winding. As a result, all the windings with the exception of the innermost winding can in each case have the shape of a triangle or trapezoid which has been rolled up or bent respectively, on the face. Said flat coils can generally also be referred to as trapezoidal flat coils, wherein a triangle represents a special form of the trapezoid in which two neighboring corners coincide so as to form a single corner.

In one embodiment having a coil group having at least three flat coils, the innermost windings of the first and of the third flat coil have in each case the shape of a rectangular trapezoid which is rolled up or bent, respectively, on the face, and the innermost winding of the second flat coil has the shape of a trapezoid which was originally equiangular in a plane and which has been rolled up or bent, respectively, on the face. The outer windings of the first and of the third flat coil in this instance substantially each have the form of a correspondingly bent rectangular trapezoid, and the outer windings of the second flat coil have the shape of a correspondingly bent, symmetrical isosceles trapezoid.

In one preferred embodiment, the widths of the flat coils vary in each case strictly monotonically along the circular path. As a result, the inductances of the flat coils can also develop strictly monotonically across the position of the flux element along the circular path (rotational angle). An unequivocal determination of the position of the flux element based on the inductance of a flat coil can be enabled as a result.

In one preferred embodiment, at least one of the flat coils comprises a plurality of planes. The planes can be disposed along the direction of a spacing of the circular path from the face. In practice, a flat coil can be formed as a printed coil in the form of a conductor on a circuit board. In order to comprise a plurality of planes, coils can be formed on a plurality of tiers of the circuit board and electrically wired to one another so as to form a flat coil. The coils on the different tiers here typically have identical shapes, faces and winding directions.

Coils here can also be attached to both sides of the tiers; for example, in a 4-tier flat coil, the individual coil planes can be attached to both sides of a (4-tier) circuit board. A respective flux element (thus a total of two flux elements) can then be present on both sides of the circuit board so as to influence the flat coil from both sides. The influencing effect is thus simplified. In this instance, a U-shaped flux element can encompass a periphery of a support disk on both sides, the coil groups being attached to the external circumference of said support disk.

In one preferred embodiment the flux element contains an electrically conductive element which extends in particular parallel to the face. The conductive element can minimize the inductance of a flat coil, said conductive element being situated in the electromagnetic field of said flat coil, and thus act as an attenuation element. The flux element here absorbs energy from the electromagnetic field and forms eddy currents in the electrically conductive material.

In another embodiment, a flux element which increases the inductance of a flat coil when said flux element is situated in the electromagnetic field of said flat coil, can be used. The flux element here is preferably made from a ferromagnetic material, such as ferrite or iron, which is a poor electrical conductor.

The object of the invention is also achieved by an electric machine according to patent claim 13. The machine contains a stator and a rotor which is rotatable relative to the stator about a rotation axis, and a sensor assembly according to one of the preceding claims, wherein the rotation axis of the sensor assembly is the rotation axis of the machine and the flux element is coupled in a rotationally fixed manner to the rotor and the coil groups are coupled in a rotationally fixed manner to the stator. A reversal of this variant (coil groups on the rotor, flux element on the stator) is also possible.

The machine and at least some of the embodiments thereof, as well as the respective advantages, have already been explained in an analogous manner in the context of the sensor assembly according to the invention.

In one preferred embodiment, the machine or the sensor assembly contains an electrically non-conducting support which is fastened to the rotor. The flux elements are mounted on the support. The support is in particular a disk or a right circular cylinder in relation to the rotation axis.

The aspect of such a support, and at least part of such embodiments, as well as the respective advantages have already been explained in an analogous manner in the context of the sensor assembly according to the invention.

With reference to the sensor assembly, the evaluation installation can comprise a processing installation which is specified for fully or partially carrying out a method described hereunder. To this end, the processing installation can comprise a programmable microcomputer or microcontroller, and the method can be present in the form of a computer program product with program code means. The computer program product can also be stored on a computer-readable data carrier. Features or advantages of the method can be applied to the sensor assembly or vice versa.

The object of the invention is therefore also achieved by a method according to claim 15, for detecting a rotational angle of a flux element of a sensor assembly according to the invention or of a machine according to the invention. The current inductance for each of the flat coils is determined in the method. A current respective individual rotational angle of the flux element is subsequently determined by means of the determined inductance of the respective flat coil. The rotational angle of the flux element is subsequently provided based on at least two matching individual rotational angles.

The method and at least some of the embodiments thereof, as well is the respective advantages, have already been explained in analogous manner in the context of the sensor assembly according to the invention and of the machine according to the invention.

The method thus comprises the steps of determining inductances of the flat coils; determining individual rotational angles of the flux element, in each case in terms of one of the determined inductances or flat coils, respectively; and providing a rotational angle of the flux element based on at least two matching individual rotational angles of the determined individual rotational angles. If the two, or in particular three or more, determined individual rotational angles match one another, the rotational angle of the flux element can be determined based on all individual rotational angles. Matching individual rotational angles typically slightly deviate from one another by virtue of imperfections during the determination. Providing the rotational angle can comprise, for example, forming a minimum, a maximum, a mean value, of the determined individual rotational angles, or selecting one individual rotational angle of the determined individual rotational angles, said selection being assigned to a predetermined flat coil of the two or three or more flat coils. If only two of the individual rotational angles match one another, the rotational angle of the flux element can be determined based on these two determined individual rotational angles.

In a general embodiment, N flat coils are provided in the region of the flux element, where preferably N>2, and furthermore preferably N is an odd number. The rotational angle of the flux element in this instance can be determined in terms of a plurality of matching individual rotational angles which are in each case assigned to one of the flat coils. In general, the sensor assembly can continue to determine the rotational angle of the flux element even after N−2 flat coils have failed. For reasons of space and the expected probability of more than one flat coil failing at the same time, it is proposed that N=3 (per coil group) is chosen.

In one preferred embodiment, the sensor assembly contains at least 3 flat coils. A defective flat coil (should such a defective flat coil be present) is identified or determined, respectively, when an individual rotational angle determined based on the inductance of said defective coil deviates from matching individual rotational angles which have been determined based on the other flat coils. This method is in particular carried out within a coil group which contains at least 3 flat coils. A signal or a message which points out the defective flat coil can be provided. The defective flat coil can be excluded from the further operation of the sensor assembly. The sensor assembly can continue to be operated in particular at least as long as no further one of the flat coils within the respective coil group is determined as being defective.

Further features, effects, and advantages of the invention are derived from the description hereunder of a preferred exemplary embodiment of the invention as well as from the appended figures. In the figures, in each case in a schematic diagram:

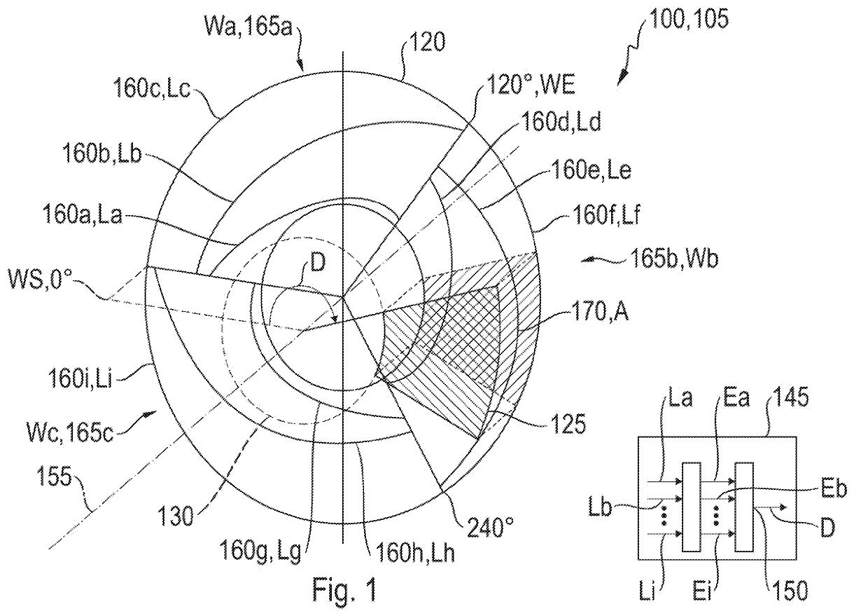

FIG. 1 shows a sensor assembly according to the invention on a machine;

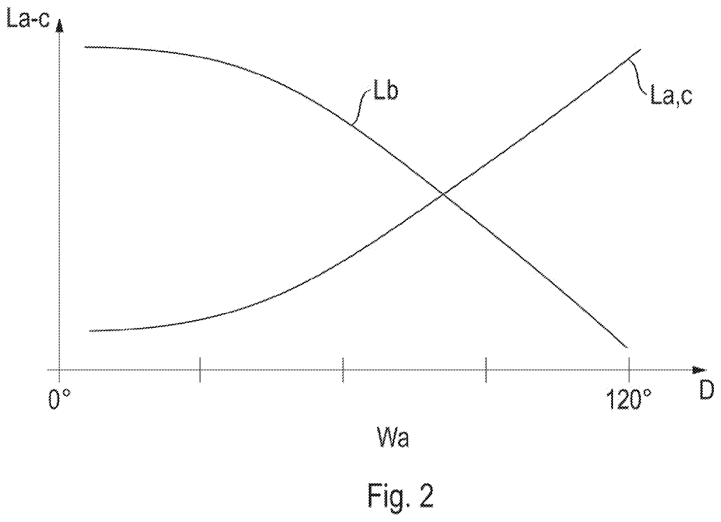

FIG. 2 shows the profile of inductances over the rotational angle in the sensor assembly from FIG. 1;

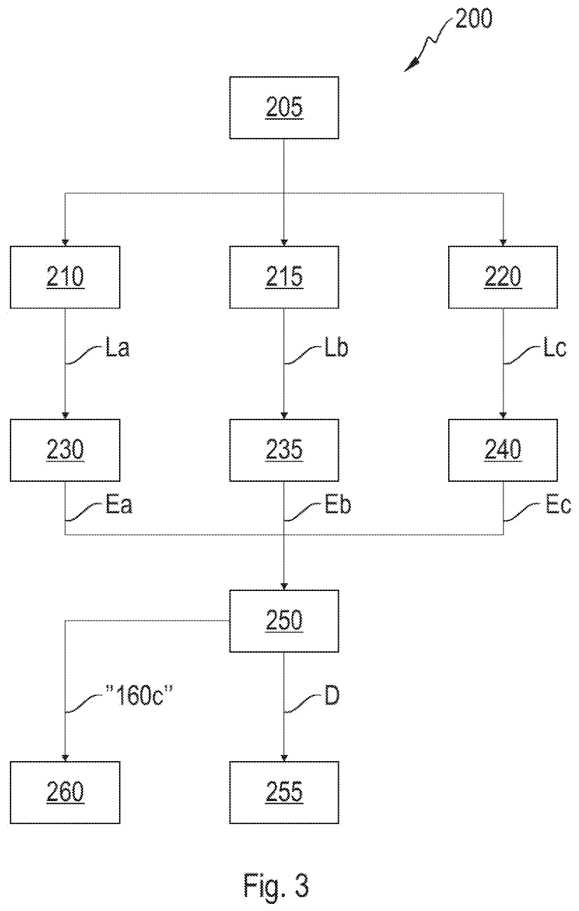

FIG. 3 shows a sequence diagram for a method for determining the rotational angle in FIG. 1;

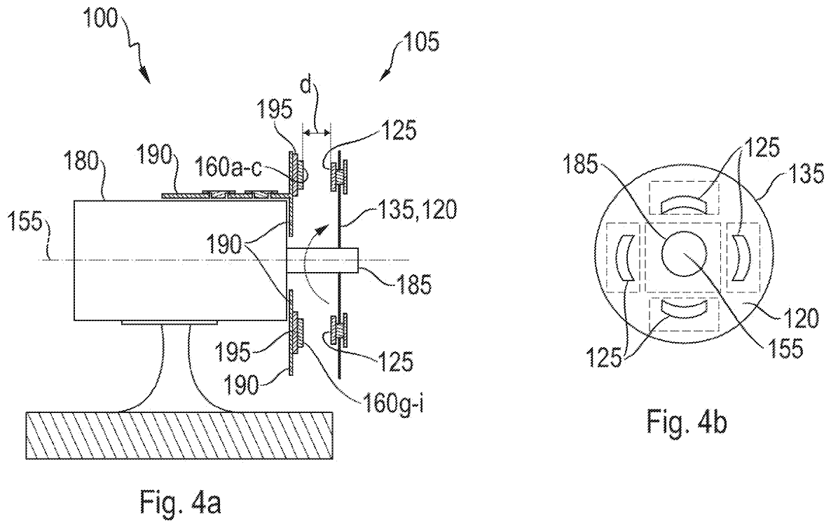

FIG. 4 shows the electric machine from FIG. 1, a) in a lateral view, and b) an alternative support having flux elements in a frontal view;

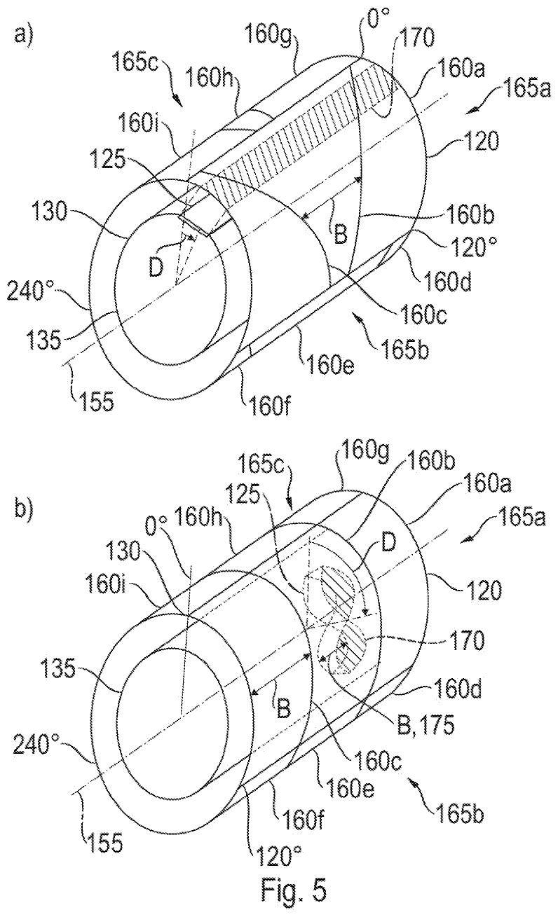

FIG. 5 shows alternative flat coils und flux elements in a cylindrical shape, a) analogous to FIG. 1, and b) having a sinusoidal flux element und homogenous flat coils;

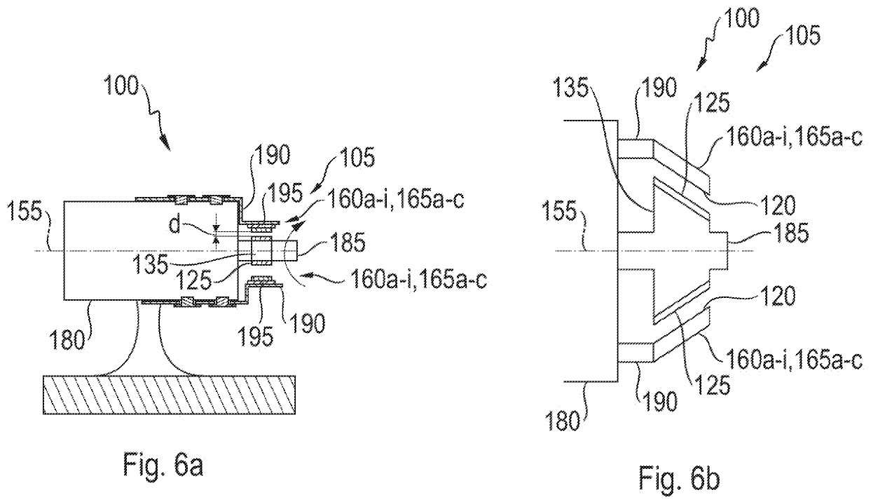

FIG. 6 shows a) the assemblies from FIG. 5 in the machine according to FIG. 4, having b) an alternative geometry in a conical shape;

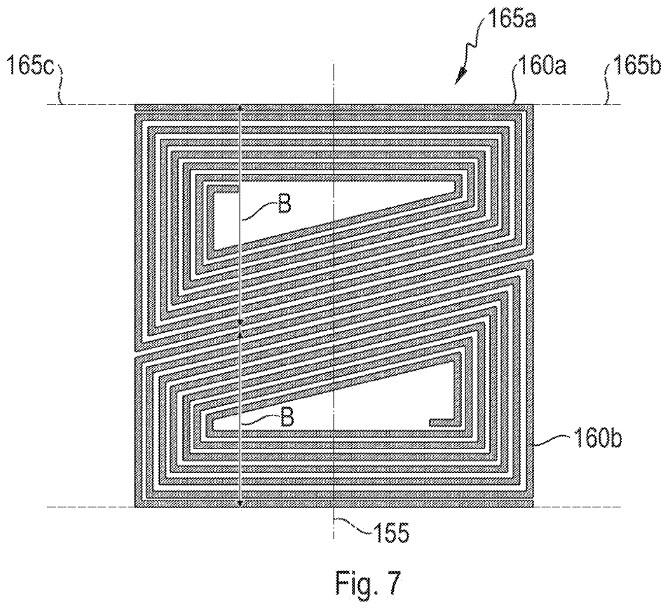

FIG. 7 shows an alternative coil group having two flat coils; and

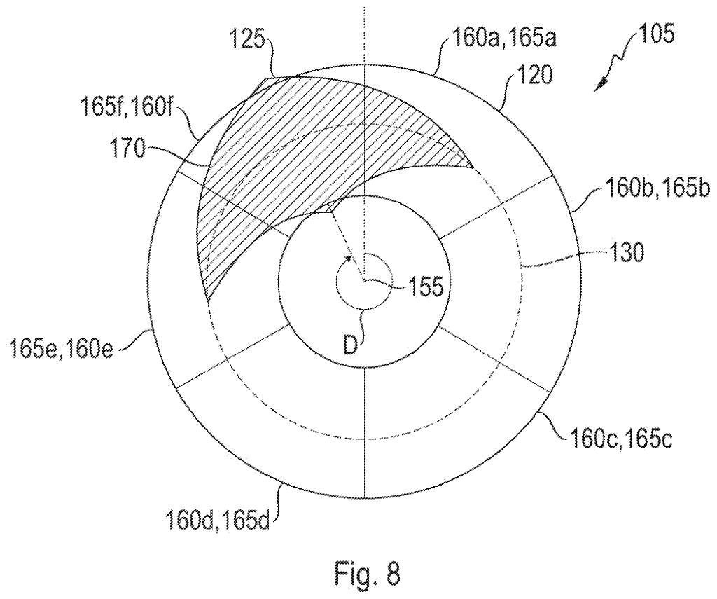

FIG. 8 shows an alternative sensor assembly having one flat coil per coil group.

FIG. 1 shows a fragment of an electric machine 100 which is not illustrated in more detail (see FIG. 4, for example), specifically only a sensor assembly 105 mounted therein. The sensor assembly 105 is specified for determining the rotational angle of a first element (flux element 125) in relation to a second element (coil groups 165a-c), as will be explained below. The machine 100 contains a stator 180 and a rotor 185 which is rotatable relative to the stator 180 about a rotation axis 155 (see FIG. 4a).

The sensor assembly 105 comprises a first flat coil 160a, a second flat coil 160b, and a third flat coil 160c which in a radial direction in terms of a rotation axis 155 of the sensor assembly 105 (coincides with the rotation axis 155 of the machine 100) in a radial direction in terms of the rotation axis 155 lie “next to one another” in a face 120, the latter here being planar and forming a circular disk. The face 120 in an axial plane here extends perpendicularly to the rotation axis 155. A flux element 125 which is rotatable along a predetermined trajectory, here a circular path 130, about the rotation axis 155 is attached so as to be axially offset along the rotation axis 155 in relation to the face 120. In the embodiment illustrated, the circular path 130 likewise coincides with a plane which is transverse to the rotation axis 155. The flux element 125 in the embodiment illustrated is an annular segment and comprises four edges which in pairs run radially, and in pairs run in the circumferential direction of the rotation axis 155, and all run parallel to the face 120.

The sensor assembly 105 onboard a motor vehicle is preferably specified for determining the rotational angle of the rotor 185 in relation to the stator 180 of the machine 100. To this end, the flux element 125 is fastened in a rotationally fixed manner to the rotor 185 or coupled thereto, and the coil groups 165a-c are fastened in a rotationally fixed manner to the stator 180 or coupled thereto, respectively. The flux element 125 here is held on a support 135 which in turn is fastened to the rotor 185.

The flat coils 160a-c form a first coil group 165a. The latter extends about the rotation axis 155 on a first rotational angle range Wa of 120° (0° to) 120°. Two further groups of three flat coils 160d-i form two further coil groups 165b-c which are identical to the first coil group 165a and therefore not explained once again. Said two further coil groups 165b-c also extend across rotational angle ranges Wb (120° to 240°) and We (240° to 0°) each of 120°. The rotational angle ranges Wa-c adjoin one another without any overlap and in a seamless manner. All rotational angles D from 0° to 360° are thus covered by flat coils 160a-i, or coil groups 165a-c, respectively.

The flat coils 160a-i here are attached to a support part 190, which is not illustrated in FIG. 1, so as to form a unit which can be separately handled. The support part 190 is attached to the stator 180 of the machine 100, and the rotor 185 of the latter is connected to the flux element 125 so that the flux element 125 is rotated along the circular path 130 in relation to the flat coils 160a-c when the machine 100, or the rotor 185 of the latter, respectively, rotates.

The support part 190 can in particular comprise a circuit board, and the flat coils 160a-i can be configured as conductors on the circuit board. The circuit board can optionally comprise a plurality of planes or tiers, respectively, a portion of a flat coil 160a-i potentially being in each case configured as a conductor and thus also as a plane on said planes or tiers, wherein the portions or planes, respectively, of a flat coil 160a-i are electrically connected to one another. The flux element 125 contains, or is composed of, an electrically conductive material or element such as copper, respectively, so as to act as an attenuation element for the inductances La-i of the flat coils 160a-i. The flux element 125 extends parallel to the face 120 and is highlighted by hatched lines.

The circular path 130 in the embodiment illustrated extends by 360° about the rotation axis 155 so that the flux element 125 in all rotational angles D, from 0° to 360°, is situated completely above (or below) the face 120.

The flat coils 160a-i are shaped such that a region 170 of each flat coil 160a-i covered by the flux element 125 is a function of the position, or a rotational angle D, respectively, of the flux element 125 along the circular path 130. The currently covered region 170 for the flat coil 160e is illustrated using cross-hatched lines. The entire region of all flat coils 160a-i which is currently covered by the flux element 170 is illustrated using differently hatched lines.

The flat coils 160a and 160c here are shaped such that the region 170 thereof that is in each case covered by the flux element 125, or the face or size A of said region 170, respectively, is the largest when the flux element 125 is situated at the rotational angle 0°, and the covered region decreases strictly monotonically when the flux element 125 is displaced in the direction of the rotational angle 120°. The flat coil 160b is shaped such that the region 170 thereof covered by the flux element 125 is the smallest when the flux element 125 is situated at the rotational angle 0° and the covered region increases strictly monotonically when the flux element 125 is displaced in the direction toward the rotational angle 120°. The disposal of the flat coil 160b in relation to the flat coils 160a,c, which runs counter to the aforementioned, is not mandatory for the functioning of the sensor assembly 105, but can however enable a particularly compact disposal of the flat coils 160a-c on the face 120. The same applies in an analogous manner to the other coil groups 165b,c.

The rotational angle range Wa of the coil group 165a extends from a start angle WS (rotational angle D=0°) to a finish angle WE (D=120°. A width B of the flat coils 160a,c in the radial direction, thus transversely to the circular path 130, decreases from the start angle WS to the finish angle WE; the corresponding width B of the flat coil 160b however increases. The widths B here vary strictly monotonically along the circular path 130 (160b: increasing; and 160a,c: decreasing).

The second flat coil 160b here in the direction transverse to the circular path 130, thus in the radial direction, lies between the flat coils 160a,c. The flat coils 160a-c of the coil group 165a conjointly occupy an annular segment of the face 120.

The flat coils 160a-c here extend across a third of the circumference, thus 120°. In the embodiment illustrated, the flat coils 160a,c are in each case shaped so as to be “trapezoidal” (transferred to the circular shape so as to be “bent” or “rolled up”), wherein mutually “parallel” base sides of the trapezoids extend in each case in the circumferential direction. The trapezoids of the flat coils 160a,c on the side facing away from the flat coil 160b, specifically at the rotational angles 0° and 120°, have in each case two internal angles of 90°.

The trapezoid of the second flat coil 160b does not have any right internal angle, in the radial direction is however “symmetrical” in relation to a circular path which lies so as to be centric in the face 120.

An evaluation installation 145 of the sensor assembly 105 is specified for determining in each case current inductances La-i of the flat coils 165a-i. To this end, both ends of each of the flat coils 165a-i are preferably connected to the evaluation installation 145 (not illustrated). In order for the inductance La-i of a flat coil 165a-i to be determined, the latter can form part of a resonant circuit, for instance of a parallel LC resonator (not illustrated), and this resonant circular can be excited at the resonance frequency thereof. The resonance frequency can be used as a measure for the inductance La-i which in turn is a function of the respective region 170 of the flat coils 160a-i covered by the flux element 125. The size of the covered region 170 is linked to the rotational angle D of the flux element 125, and as a result thereof to the rotation angle D of the rotor 185 such that the rotational angle D (or an individual rotational angle Ea-i) of the rotor 185 can be determined based on the inductance La-i of a flat coil 165a-i.

The evaluation installation 145 is furthermore preferably specified for determining the rotational angle D of the rotor 185, or of the flux element 125, respectively, based on individual rotational angles Ea-i which have been individually determined in each case in terms of one of the flat coils 165a-i. It can in particular be determined here whether two or more individual rotational angles Ea-i, which have in each case been determined in terms of one of the flat coils 165a-i, match one another. If this is the case, the rotational angle Din terms of matching individual rotational angles Ea-i can thus be determined. The determined rotational angle D can be externally provided by way of an interface 150. The provided rotational angle D can be continuously stated within a predetermined range, or relate discretely to a predetermined circumferential position (for example, “0 degrees/“180 degrees”). It can moreover be determined whether one of the flat coils 165a-i has any defect.

The illustration in FIG. 2 shows profiles, which are exemplary in terms of quality, of inductances La-c of the flat coils 165a-c as a function of different rotational angles D from 0° to 120° of the flux element 125 in the first angular range Wa. The rotational angle D of the flux element 125 is plotted in the horizontal direction, and the inductance La-c is plotted in the vertical direction. Inductances La,c of the flat coils 165a,c are displayed as being identical while said inductances in practice typically deviate at least slightly from one another, even when the flat coils 165a,c in the radial direction are configured so as to be mutually “symmetrical” in relation to the rotation axis 155.

FIG. 3 shows a sequence diagram of a method 200 for determining the rotational angle D of the flux element 125 in relation to an assembly of coils 165a-i in a sensor assembly 105, as in that of FIG. 1. The method 200 can in particular be carried out with the aid of the evaluation installation 145 and commences at a step 205. For the sake of clarity, said method 200 is illustrated in a merely exemplary manner for the coil group 165a, in a manner representing all coil groups 165a-c and all flat coils 160a-i.

An inductance La of the flat coil 160a is determined in a step 210. Inductances Lb,c of the flat coils 165b,c are determined in an analogous manner in steps 215 and 220. Steps 210 to 220 can be carried out in sequence, in a synchronized manner, or concurrently.

In steps 230 to 240, a corresponding individual rotational angle Ea-c of the flux element 125 is then determined for each determined inductance La-c, for example based on a table which displays inductances La-c at rotational angles D, or based of a known correlation which permits a functional determination of the rotational angle D based on the inductance La-c.

The determined individual rotational angles Ea-c are compared with one another in a step 250. If individual rotational angles Ea-c of a plurality of flat coils 165a-c match one another, a rotational angle D of the flux element 125 is determined based on these determined individual rotational angles Ea-c, and provided in a step 225, for example by way of the interface 150.

For example, if individual rotational angles Ea,b which in the embodiment illustrated in FIG. 1 have been determined in terms of the flat coils 160a,b are substantially identical, and if the individual rotational angle Ec which has been determined in terms of the flat coil 160c deviates from the other two individual rotational angles Ea,b by more than a predetermined measure, the rotational angle D of the flux element 125 in terms of the two matching individual rotational angles Ea,b can thus be determined. In this case, the flat coil 160c, in terms of which an individual rotational angle Ec which deviates from the others has been determined, can be determined as being defective in a step 260. A flat coil 160c which has been determined as being defective cannot be used for determining a rotational angle D in a following run of the steps illustrated. The method 200 can be run in a cycled manner so as to determine the rotational angle D at predetermined temporal intervals.

FIG. 4 shows the sensor assembly 105 from FIG. 1 once again in the context of the machine 100 in a) a lateral view and b) the support 105 in a frontal view. FIG. 4 here shows a variant in which a total of four flux elements 125 are present on the support 135. Said flux elements 125 here extend in the circumferential direction in relation to the rotation axis 155. The support 135 has a central bore for mounting on the rotor 185, or the corresponding shaft of the motor or of the machine 100, respectively. The flux element 125 reduces the inductance La-i of the coil 160a-i when said flux element 125 is “above” said coil 160a-i or slides across the latter. The flux element here can also be referred to as a “copper activator” in the periphery of the non-conducting disc or of the support 135, respectively. A support part 190 for the flat coils 160a-i, or a circuit board 195 which is symbolically indicated here and on which said flat coils 160a-i are attached, is fastened to the stator 180, or a motor casing, respectively, for example by way of screws or rivets. The motor, or the machine 100, respectively, is fastened to a fixed assembly base by way of a mounting column which is not explained in more detail.

FIG. 5a shows an alternative sensor assembly 105. The face 120 here is a right circular-cylindrical shell about the rotation axis 155. The flat coils 160a-i here are also sub-portions of the circular-cylindrical shell. The coils are fundamentally shaped as in FIG. 1, that is to say so as to be “trapezoidal” in a plane, but “rolled up” or “bent”, respectively, on the circular-cylindrical shell. Three identical coil groups (at least partially visible) each of three flat coils (as in FIG. 1) are again present here. Each of the coil groups in the circumferential direction about the rotation axis 155 again extends about rotational angle ranges Wa-c each of 120°. As in FIG. 1, the widths B (now measured in the axial direction) of the flat coils 160a-i within a coil group 165 here also increase or decrease strictly monotonically in an opposing manner in the circumferential direction. The flux element 125 is received in a cylindrical support 135 which is fixedly fastened to the rotor 185. The flat coils 160a-i conjointly occupy a right circular-cylindrical shell.

FIG. 5b shows a further variant of a sensor assembly 125, fundamentally according to FIG. 5. The flux element 125 here is embodied with a characteristic 175, specifically the width B of said flux element 125, which is sinusoidal in the circumferential direction, or variable in a sinusoidal manner in the circumferential direction, respectively. The flat coils 160a-i here however have in each case a constant width B.

FIG. 6a (optionally and therefore not specifically illustrated) shows the sensor assembly 105 from FIG. 5a,b installed in the machine 100 according to FIG. 4a. The support 135 is a thick PVC/plastic/polymer ring for fastening the activator, or the flux element 125, respectively, on the motor shaft, or the rotor 185, respectively. The inductive sensors, or flat coils 160a-i, respectively, here are multiple windings/multiple planes flat coils.

A spacing d in FIGS. 4a and 6a identifies in each case the spacing between sensors (flat coils 160) and the activator (flux element 125).

FIG. 6b shows an alternative shape, specifically a conical shape, for flat coils 160, flux elements 125, the support 135 and the support part 190. The embodiment here is a conical shape and thus an “intermediate shape” between the “disk shape” (FIG. 1) and the “cylindrical shape” (FIG. 5). The explanations above otherwise apply in analogous manner.

FIG. 7 shows an example for a coil group 165a which has only two flat coils 160a,b and is suitable for the embodiments of FIGS. 5a,b, for example. Here too, the widths B (measured in the axial direction) are embodied so as to decrease and increase strictly monotonically in an opposing manner in the circumferential direction. To be seen is in each case a first plane of the flat coils having a multiplicity of windings. Further planes adjoin “below” the paper plane, so as to be invisible here.

FIG. 8 in a plan view in the direction of the rotation axis 155 shows an alternative embodiment of a sensor assembly, fundamentally corresponding to that of FIG. 1. A planar sensor assembly of six square coils and one rhombic flux element has been “bent” or “unrolled”, respectively, on a circular shape. Each of the six coil groups 165a-f here has in each case a single flat coil 160a-f. The corresponding planar initial sensor assembly from FIG. 1 is known in the document “A. K. Palit, ‘Frequency Response Modeling of Inductive Position Sensor with Finite Element Tools’, Proceedings of the 2014 COMSOL Conference in Cambridge, https://www.comsol.com/paper/download/199331/palit_paper.pdf, downloaded on 12/05/2018”.

### LIST OF REFERENCE SIGNS

100 Machine
105 Sensor assembly
120 Face
125 Flux element
130 Circular path
135 Support
145 Evaluation installation
150 Interface
155 Rotation axis
160a-i Flat coil
165a-c Coil group
170 Region
175 Characteristic
180 Stator
185 Rotor
190 Support part
195 Circuit board
200 Method
205 Step start
210 Step inductance La
215 Step inductance Lb
220 Step inductance Lc
230 Step individual rotational angle Ea
235 Step individual rotational angle Eb
240 Step individual rotational angle Ec
250 Step majority decision
255 Step providing
260 Step defective flat coil
Wa-c Rotational angle range
D Rotational angle
La-i Inductance
Ea-i Individual rotational angle
A Size
WS Start angle
WE Finish angle
B Width
d Spacing

1. A sensor assembly for detecting a rotational angle of at least one flux element comprising:
the at least one flux element; and
at least one coil group comprising at least one flat coil;
wherein the at least one flat coil extends along a face which concentrically surrounds the rotation axis;
wherein the face runs in parallel along the circular path, and all of the at least one flat coil of the at least one coil group each extend across the same rotational angular range;
wherein the at least one flat coil is shaped in such a manner that a current inductance of the at least one flat coil is a function of the current rotational angle of the at least one flux element;
wherein the sensor assembly further comprises an evaluation installation configured to determine the current inductance for each of the at least one flat coil and to determine a current respective individual rotational angle of the at least one flux element by means of the determined inductance of each of the respective at least one flat coil, and to provide the rotational angle of the at least one flux element based on at least two matching individual rotational angles.

2. The sensor assembly of claim 1, wherein the sensor assembly contains comprises at least two coil groups which extend across different rotational angle ranges in the circumferential direction.

3. The sensor assembly of claim 2, wherein at least two of the rotational angle ranges do not overlap one another and seamlessly adjoin one another.

4. The sensor assembly of claim 1, wherein the face at least one of:
is planar and extends transversely to the rotation axis, or
has at least one of a conical shape, a circular conical shape, or a shape of a lateral surface of a circular cylinder about the rotation axis.

5. The sensor assembly of claim 1, wherein the at least one flux element has a sinusoidal characteristic along the circular path.

6. The sensor assembly off claim 1, wherein the at least one flat coil is shaped in such a manner that a current size of a region of the at least one flat coil covered by the at least one flux element at a given time is a function of the rotational angle of the at least one flux element at that same given time.

7. The sensor assembly of claim 6, wherein the at least one flat coil of the at least one coil group comprises a first flat coil and a second flat coil, and
wherein a rotational angle range of the at least one coil group extends between a start angle and a finish angle, and a width of the first flat coil, proceeding from the start angle, decreases transversely to the circular path, and a width of the second flat coil, proceeding from the start angle, increases.

8. The sensor assembly of claim 1, wherein the at least one coil group comprises at least a first flat coil, a second flat coil, and a third flat coil, wherein the second flat coil in a direction transverse to the circular path lies between the first flat coil and the third flat coil.

9. The sensor assembly of claim 1 wherein the at least one flat coil of the at least one coil group comprises at least two flat coils that conjointly occupy at least one of an annular segment, a cone shell, or a right circular-cylindrical shell of the face.

10. The sensor assembly of claim 1, further comprising a plurality of flat coils, wherein widths of each one of the flat coils transversely to the circular path vary strictly monotonically along the circular path.

11. The sensor assembly of claim 1, wherein the at least one flat coil comprises a plurality of planes.

12. The sensor assembly of claim 1, wherein the at least one flux element contains an electrically conductive element which extends parallel to the face.

13. An electric machine comprising:
the sensor assembly of claim 1;
a stator; and
a rotor which is rotatable relative to the stator about a machine rotation axis,
wherein the rotation axis of the sensor assembly is that of the machine rotation axis, and the at least one flux element is coupled in a rotationally fixed manner to the rotor and the at least one coil group is coupled in a rotationally fixed manner to the stator, or vice versa.

14. The electric machine of claim 13, wherein the at least one flux element is mounted on a non-conducting support which is fastened to the rotor.

15. A method for detecting a rotational angle of a flux element of a sensor assembly comprising a plurality of flat coils, the method comprising:
determining a current inductance for each of the plurality of flat coils;
determining a current respective individual rotational angle of the flux element by means of the determined inductance of the respective flat coil; and
providing the rotational angle of the flux element based on at least two matching individual rotational angles.

16. The method of claim 15, wherein the sensor assembly contains at least three flat coils, wherein the method further comprises:
detecting a defective flat coil when an individual rotational angle determined based on the inductance of said flat coil deviates from mutually matching individual rotational angles of at least one other flat coil.
